(19) United States
(12) Patent Application Publication
(10) Pub. No.: US 2021/0344198 A1
(43) Pub. Date: Nov. 4, 2021

(54) Reactive Power Control Method for an Integrated Wind and Solar Power System

(71) Applicant: General Electric Company, Schenectady, NY (US)

(72) Inventors: Arvind Kumar Tiwari, Bangalore (IN); Vaidhya Nath Venkitanarayanan, Schenectady, NY (US); Yashomani Yashodhan Kolhatkar, Bangalore (IN); Veena Padma Rao, Bangalore (IN)

(21) Appl. No.: 17/274,281

(22) PCT Filed: Sep. 5, 2019
(86) PCT No.: PCT/US2019/049629

§ 371 Date: Mar. 8, 2021

(30) Foreign Application Priority Data
Sep. 7, 2018 (IN) 201841033694

(51) Int. Cl. H02J 3/18; H02J 3/50; H02J 3/38

(52) U.S. Cl. CPC H02J 3/18; H02J 3/50; H02J 2300/40; H02J 2300/24; H02J 2300/28; H02J 3/381

(57) ABSTRACT

A method of operating a power generation system (100) employing a generator (110) and a solar power source (120) is provided. The method includes the steps of determining (310) if a wind speed is less than a cut-in speed, calculating (315) a reactive power demand for an electrical grid (102), calculating (320) a reactive power capability of a line side converter (140), determining (325) if the reactive power demand is greater than the reactive power capability, and calculating (330) a reactive power capability of the line side converter (140) and a rotor side converter (130). The method also includes the steps of determining (335) if the reactive power demand is greater than the reactive power capability of the line side converter (140) and the rotor side converter (130), and reducing solar power generation or reconfiguring the line side converter (140) and/or the rotor side converter (130) to meet reactive power demand.

### BACKGROUND

The present application relates generally to generation of electrical power and more particularly relates to a reactive power control method for an integrated wind and solar power system.

Renewable energy sources, such as solar and wind farms, are becoming more economically viable as traditional fossil fuel prices continue to rise. Existing electrical power distribution (grid) infrastructure can be utilized for distributing power from renewable energy sources if the proper control system is in place for coordinating power produced with the demand of the utility. Demand for power can be measured and the demand signal can be used to control the amount of power supplied to the electrical grid by the renewable source.

Real power is generated or consumed when voltage and current are in phase. Reactive power is generated or consumed when voltage and current are 90 degrees out of phase. A purely capacitive or purely inductive load will generally consume only reactive power (with the exception of small resistive losses) and no appreciative real power is transferred to the load. Reactive power is measured by a quantity called volts-amps-reactive, or VARs, which is a convenient mathematical quantity because apparent power is the vector sum of VARs and watts. The stability of the electrical grid is related to the generation and/or consumption of reactive power. Therefore, it is necessary to control the reactive power output from the renewable energy source to fulfill electrical demand while providing stability for the electrical grid.

Previous reactive power management methods and systems regulate VAR commands, which are sent to wind turbines to control the instantaneous reactive power production of each wind turbine. However, such methods and systems experience difficulty when coordinating reactive power response from integrated wind and solar power systems. Therefore, there exists a need for reactive power regulation and voltage support for integrated wind and solar power systems.

### BRIEF DESCRIPTION

In accordance with an aspect, a method of operating a power generation system employing a generator and a solar power source is provided. The generator is electrically coupled to a rotor side converter and a point of common coupling (PCC), the PCC being electrically coupled to a line side converter, a DC-DC converter is electrically coupled to an output of the rotor side converter and an input of the line side converter. The DC-DC converter is electrically coupled to the solar power source. The method comprising the following steps: (a) determining if a wind speed is less than a cut-in speed; (b) calculating a reactive power demand for an electrical grid; (c) calculating a reactive power capability of the line side converter; (d) determining if the reactive power demand is greater than the reactive power capability; (e) calculating a reactive power capability of the line side converter and the rotor side converter; (0 determining if the reactive power demand is greater than the reactive power capability of the line side converter and the rotor side converter. The method also includes step (g) reducing solar power generation if the reactive power demand is greater than the reactive power capability of the line side converter and the rotor side converter and repeating the determining if the reactive power demand is greater than the reactive power capability of the line side converter and the rotor side converter step, or reconfiguring at least one of the line side converter and the rotor side converter to meet reactive power demand.

In accordance with another aspect a method of operating a power generation system employing a generator and a secondary power source is provided. The generator is electrically coupled to a rotor side converter and a point of common coupling (PCC), the PCC being electrically coupled to a line side converter, a DC-DC converter is electrically coupled to an output of the rotor side converter and an input of the line side converter. The DC-DC converter is electrically coupled to the secondary power source. The method comprising the following steps: (a) determining if a wind speed is less than a cut-in speed; (b) calculating a reactive power demand for an electrical grid; (c) calculating a reactive power capability of the line side converter; (d) determining if the reactive power demand is greater than the reactive power capability; (e) calculating a reactive power capability of the line side converter and the rotor side converter; (0 determining if the reactive power demand is greater than the reactive power capability of the line side converter and the rotor side converter. The method also includes step (g) reducing secondary power generation if the reactive power demand is greater than the reactive power capability of the line side converter and the rotor side converter and repeating the determining if the reactive power demand is greater than the reactive power capability of the line side converter and the rotor side converter step, or reconfiguring at least one of the line side converter and the rotor side converter to meet reactive power demand.

In accordance with another aspect a method of operating a power generation system employing a generator and a battery power source is provided. The generator is electrically coupled to a rotor side converter and a point of common coupling (PCC), the PCC being electrically coupled to a line side converter, a DC-DC converter is electrically coupled to an output of the rotor side converter and an input of the line side converter. The DC-DC converter is electrically coupled to the battery power source. The method comprising the following steps: (a) determining if a wind speed is less than a cut-in speed; (b) calculating a reactive power demand for an electrical grid; (c) calculating a reactive power capability of the line side converter; (d) determining if the reactive power demand is greater than the reactive power capability; (e) calculating a reactive power capability of the line side converter and the rotor side converter; (0 determining if the reactive power demand is greater than the reactive power capability of the line side converter and the rotor side converter. The method also includes step (g) reducing battery power generation if the reactive power demand is greater than the reactive power capability of the line side converter and the rotor side converter and repeating the determining if the reactive power demand is greater than the reactive power capability of the line side converter and the rotor side converter step, or reconfiguring at least one of the line side converter and the rotor side converter to meet reactive power demand.

### BRIEF DESCRIPTION OF THE DRAWINGS

These and other features, aspects, and advantages of the present invention will become better understood when the following detailed description is read with reference to the accompanying drawings in which like characters represent like parts throughout the drawings, wherein:

FIG. 1 illustrates a block diagram of an integrated wind and solar power system.

FIG. 2 illustrates a chart of common reactive power vs. real power requirements/capability for power generating systems.

FIG. 3 illustrates a method of operating a power generating system, according to an aspect of the disclosure.

FIG. 4 illustrates a method of calculating a reactive power capability for a plurality of wind turbines, according to an aspect of the disclosure.

FIG. 5 illustrates a method of calculating a reactive power capability for a plurality of wind turbines, according to an aspect of the disclosure.

FIG. 6 illustrates a method of operating a power generation system, according to an aspect of the disclosure.

FIG. 7 illustrates a block diagram of an integrated wind and solar power system, according to an aspect of the disclosure.

### DETAILED DESCRIPTION

The specification may be best understood with reference to the detailed figures and description set forth herein. Various embodiments are described hereinafter with reference to the figures. However, those skilled in the art will readily appreciate that the detailed description given herein with respect to these figures is just for explanatory purposes as the method and the system extend beyond the described embodiments.

In the following specification and the claims, the singular forms “a”, “an” and “the” include plural referents unless the context clearly dictates otherwise. As used herein, the term “or” is not meant to be exclusive and refers to at least one of the referenced components being present and includes instances in which a combination of the referenced components may be present, unless the context clearly dictates otherwise.

Approximating language, as used herein throughout the specification and claims, may be applied to modify any quantitative representation that could permissibly vary without resulting in a change in the basic function to which it is related. Accordingly, a value modified by a term or terms, such as “about”, and “substantially” is not to be limited to the precise value specified. Here and throughout the specification and claims, range limitations may be combined and/or interchanged; such ranges are identified and include all the sub-ranges contained therein unless context or language indicates otherwise.

As used herein, the terms “may” and “may be” indicate a possibility of an occurrence within a set of circumstances; a possession of a specified property, characteristic or function; and/or qualify another verb by expressing one or more of an ability, capability, or possibility associated with the qualified verb. Accordingly, usage of “may” and “may be” indicates that a modified term is apparently appropriate, capable, or suitable for an indicated capacity, function, or usage, while taking into account that in some circumstances, the modified term may sometimes not be appropriate, capable, or suitable.

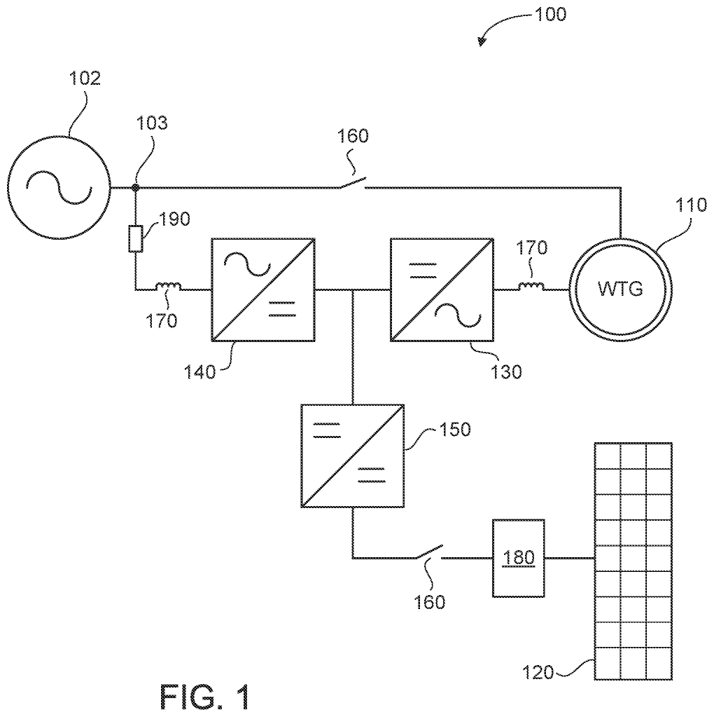

FIG. 1 illustrates a block diagram of an integrated wind and solar power system 100. The integrated wind and solar power system 100 is electrically connected to an electric grid 102 at a point of common coupling (PCC) 103. The electric grid 102 may include an interconnected network for delivering electricity from one or more power generating stations to consumers through high/medium voltage transmission lines. Electrical loads (not shown) on grid 102 may be constituted by a plurality of electrical devices that consume electricity from the electric grid 102. In some instances, the electric grid 102 may not be available, for example, in case of an islanded mode of operation. Although the integrated wind and solar power system 100 is coupled to the electric grid 102, there may be no power delivered to the electrical grid 102 due to fault or outage of the electric grid 102.

The integrated wind and solar power system 100 includes one or more wind turbines, and each wind turbine has a generator 110. As one example only, the generator 110 may be a doubly-fed induction generator (DFIG). A photo-voltaic (PV) or solar power source 120 also forms part of the integrated wind and solar power system. The integrated wind and solar power system 100 includes a rotor side converter 130, a line (or grid) side converter 140, and a DC-DC converter 150. The rotor side converter is an AC-DC converter that converts AC output power from the generator 110 to DC power. Under certain other operating conditions, the rotor side converter 130 converts DC power from DC-DC converter 150 and/or from the line side converter 140 to AC power fed to the generator. The line side converter 140 converts DC power output from both the rotor side converter 130 and DC-DC converter 150 into AC power, for subsequent transmission onto grid 102. Under certain other operating conditions, the line side converter 140 draws AC power from grid 102 and converts to DC power. The integrated wind and solar power system 100 may also include a central controller (not shown) operatively coupled to at least one of the wind turbine, generator 110, solar source 120, and converters 130, 140 and 150 to control their respective operations. The integrated wind and solar power system 100 may also include a variety of switches 160, inductors 170, filters 180 and fuses 190.

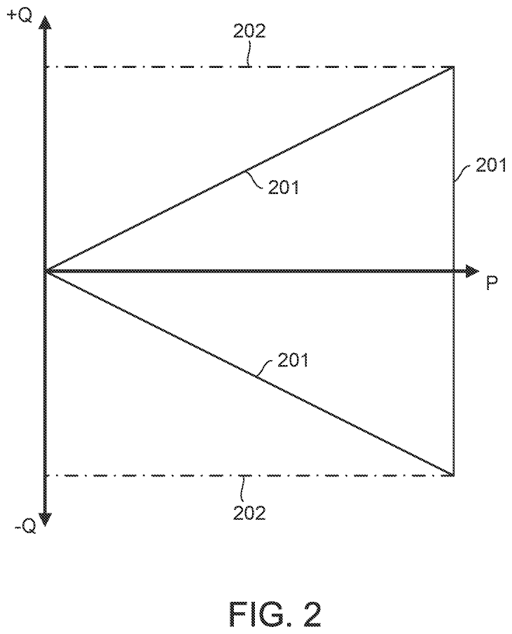

FIG. 2 illustrates a chart of common reactive power vs. real power requirements/capability for power generating systems. Reactive power (Q) is the vertical axis and the horizontal axis is real power (P). The triangular curve 201 provides zero reactive power at zero real power. A lagging power factor is represented by the negative Q portion of curve 201, and a leading power factor is represented by the positive Q portion of curve 201. A rectangular reactive power capability is illustrated by lines 202. Rectangular reactive power capabilities may be used by power generating systems to provide voltage regulation under zero power generation scenarios (e.g., no wind or zero sun (night time) situations). In addition to zero power generation scenarios, there are also very low power generation scenarios, and in this case the rectangular reactive power capability would have its left vertical line closer to the origin instead of passing through origin. There are also D-shaped curves (not shown) for decreasing reactive power capability with increasing real power generation.

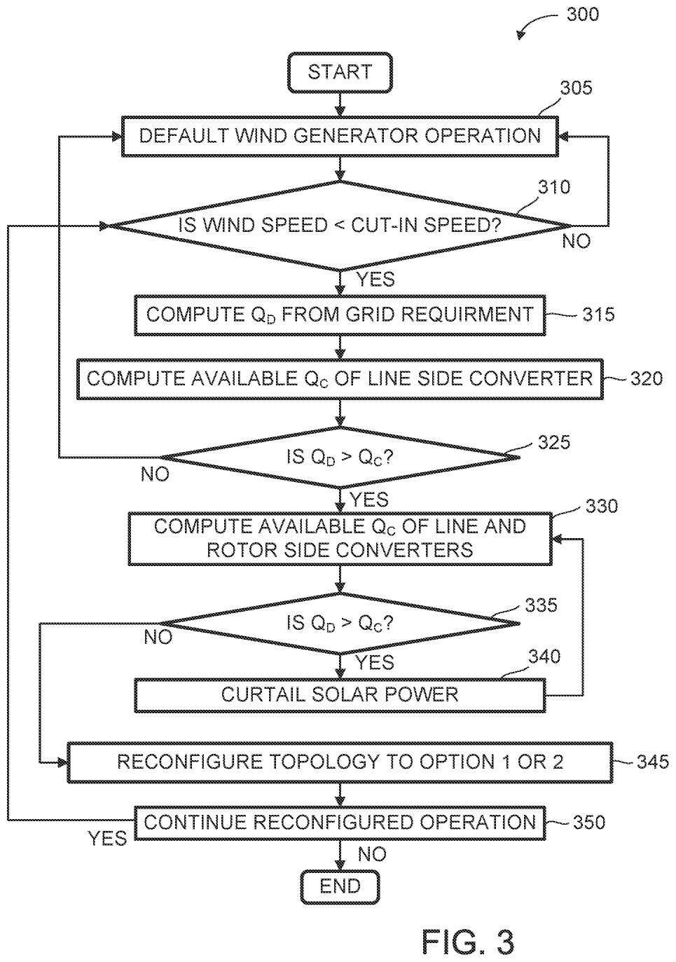

FIG. 3 illustrates a method 300 of operating a power generating system, according to an aspect of the disclosure. In step 305, a default operating state of the wind turbine/generator 110 is selected. A default state or default mode may be (1) where reactive power capability is driven primarily by the generator 110 and wind speed is equal to or above the cut-in speed of the wind turbine, or (2) where reactive power capability is driven primarily by the converter 130 and/or 140 and wind speed is below the cut-in speed and the solar power source 120 is not generating power. In step 310, a determining step determines if a wind speed is less than a cut-in speed for the wind turbine. For example, a typical cut-in wind speed may be about 4 meters/second, and this is the wind speed where the wind turbine begins to start generating real power. If the wind speed is less than the cut-in speed, the method continues to step 315. However, if the wind speed is equal to or greater than the cut-in speed, then the method goes back to step 305.

In step 315, a calculating step calculates (or computes) a reactive power demand Q_{D} for the electrical grid 102. Demands for reactive power are normally sent from the electrical grid administrator/operator to the power generating stations via an electronic dispatch logging (EDL) system. The flows of reactive power on the electrical grid affect voltage levels. Unlike system frequency, which is consistent across the grid, voltages experienced at points across the grid form a ‘voltage profile’, which is uniquely related to the prevailing real and reactive power supply and demand. The electrical grid administrator/operator must manage voltage levels on a local level to meet the varying needs of the system. The electrical grid administrator/operator constantly monitors grid conditions and sends out demands for reactive power when required.

In step 320, a calculating step calculates the reactive power capability Q_{C} of the line side converter 140. In step 325, a determining step determines if the reactive power demand Q_{D} is greater than the reactive power capability Q_{C}. If the reactive power demand Q_{D} is equal to or less than the reactive power capability Q_{C}, then the system 100 can meet the reactive power demand and the method goes back to step 305. However, if the reactive power demand Q_{D} is greater than the reactive power capability Q_{C}, then system 100 cannot meet the reactive power demand/target, and the method continues to step 330.

In step 330, a calculating step calculates a reactive power capability Q_{C} of the line side converter 140 and the rotor side converter 130. By combining the reactive power capabilities of both the line side converter 140 and the rotor side converter 130, the reactive power capability should be increased. In step 335, a determining step determines if the reactive power demand Q_{D} is greater than the reactive power capability Q_{C} of both the line side converter 140 and the rotor side converter 130. If the reactive power demand Q_{D} is greater than the reactive power capability Q_{C} of both the line side converter 140 and the rotor side converter 130, then the method continues to step 340. Solar power generation is curtailed or reduced in step 340, which may be accomplished by controlling the solar power output or by known methods in the art to reduce solar power output. Alternatively, this may be accomplished by electrically isolating or disconnecting some or all of the photovoltaic panels in solar power source 120. Steps 330, 335 and 340 are then repeated until reactive power capability Q_{C} of both the line side converter 140 and the rotor side converter 130 is greater than reactive power demand Q_{D}. The method then moves to step 345 in which the system 100 is reconfigured into one of two default modes.

However, if the reactive power demand Q_{D} is equal to or less than the reactive power capability Q_{C} of both the line side converter 140 and the rotor side converter 130, then the method moves to step 345, which the system 100 is reconfigured into one of two default modes. The default modes are option (1) where reactive power capability is driven primarily by the generator 110 and wind speed is equal to or above the cut-in speed of the wind turbine, or option (2) where reactive power capability is driven primarily by the converter 130 and/or 140 and wind speed is below the cut-in speed and the solar power source 120 is not generating power. The method subsequently moves to step 350, which continues the currently reconfigured operation of system 100, and then goes back to step 310 to continue monitoring the wind speed.

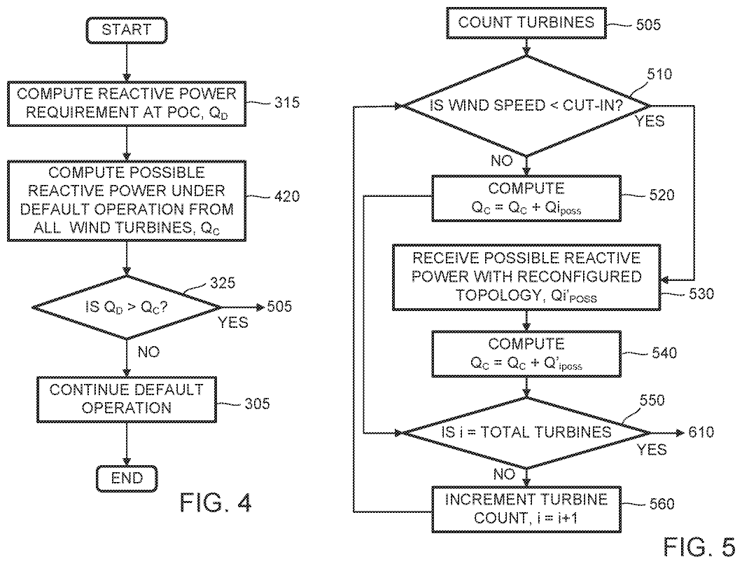

FIG. 4 illustrates a method of calculating a reactive power capability for a plurality of wind turbines, according to an aspect of the disclosure. Step 315 is the same as step 315 in FIG. 3. Step 420 is very similar to step 320 in FIG. 3, but the reactive power capability Q_{C} for a plurality of wind turbines is calculated when operating in a default mode. For example, the reactive power capability Q_{C} for a plurality of, or all of, the wind turbines in a wind farm is calculated and totaled. This aggregate reactive power capability Q_{C} is then compared to the reactive power demand Q_{D} in subsequent step 325. If Q_{D} is equal to or less than the aggregate Q_{C}, then default operation is continued for system 100 in step 305. However, if Q_{D} is greater than the aggregate Q_{C}, then the method moves to step 510 (shown in FIG. 5).

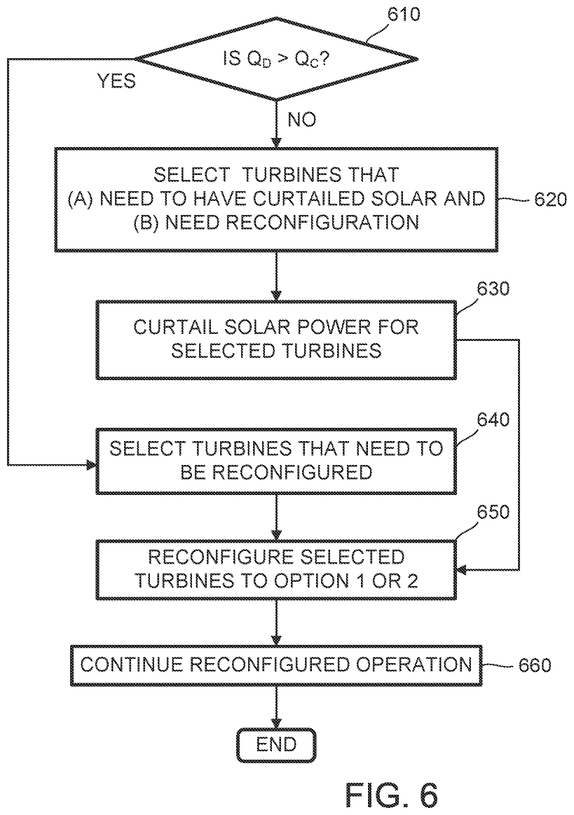

FIG. 5 illustrates a method of calculating a reactive power capability for a plurality of wind turbines, according to an aspect of the disclosure. Referring back to FIG. 4 and step 325, if the aggregate reactive power capability Q_{C} is less than the reactive power demand Q_{D} then the method proceeds to step 505. In step 505 the total number of wind turbines in a wind farm is counted, and the turbine count is initiated to i equals 1 and Q_{C} equals 0. In step 510 the wind speed is compared to the cut-in wind speed. If the wind speed is less than the cut-in speed, then the method proceeds to step 530, and in the alternative the method proceeds to step 520. In step 520, the aggregate reactive power capability Q_{C} is calculated. Q_{C} is equal to the current aggregate reactive power capability total Q_{C} plus the reactive power capability of an additional single wind turbine Q′ᵢₚₒₛₛ, where i is the current wind turbine selected. Step 520 then proceeds to step 550, which determines if the total of wind turbines has been reached. If not, then the method returns to step 510. If yes, then the method proceeds to step 610 (in FIG. 6).

If the answer to step 510 is yes (i.e., wind speed is greater than cut-in speed), then the method proceeds to step 530, which receives the possible reactive power capability Q′ᵢₚₒₛₛ with the currently reconfigured system topology. Step 530 proceeds to step 540 which calculates the aggregate reactive power capability Q_{C}. Q_{C} is equal to the current aggregate reactive power capability total Q_{C} plus the reactive power capability of an additional single wind turbine Q′ᵢₚₒₛₛ, where i is the current wind turbine selected. Step 540 proceeds to step 550, which determines if i has reached the total number of wind turbines. As described above, if the total number of wind turbines has been reached, then the method proceeds to step 610, else the method proceeds to step 560 which increments the turbine count i by 1 and then returns to step 510.

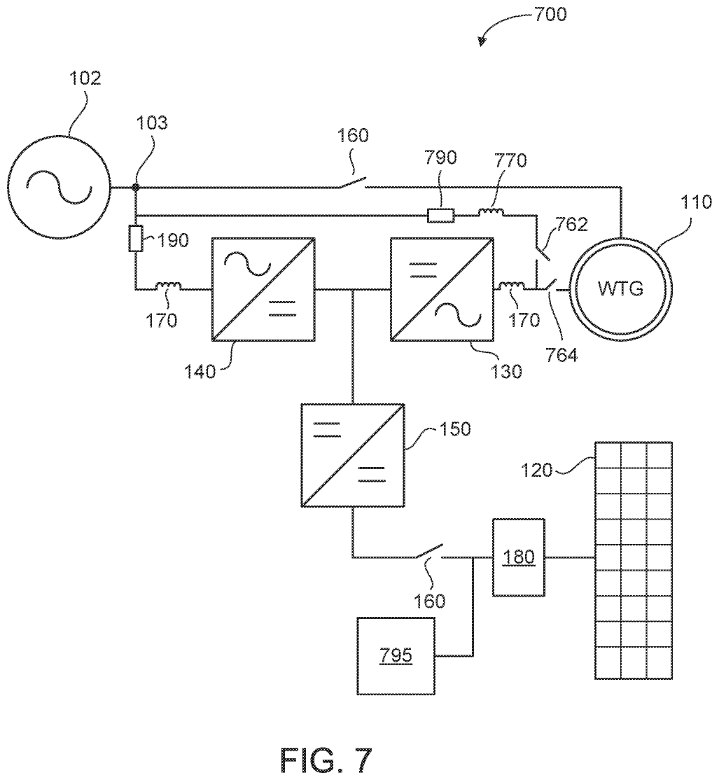

FIG. 6 illustrates a method of operating a power generation system, according to an aspect of the disclosure. In step 550 (of FIG. 5) if the total number of wind turbines has been reached, then the method proceeds to step 610, which evaluates if the reactive power demand Q_{D} is great than the aggregate reactive power capability Q_{C}. If the answer is yes, then the method proceeds to step 640 (where select turbines are identified for reconfiguration), and if not then the method proceeds to step 620. In step 620, select wind turbines and solar power sources which need to have the solar power production reduced are thereby reconfigured into a new operating mode. In step 630 the solar power for the selected turbines is curtailed. For example, 10 turbines out of 100 wind turbines in a wind farm may have the solar power production curtailed so that the reactive power production may be increased for these wind turbines. Step 630 then proceeds to step 650 where selected wind turbines are reconfigured to option 1 or option 2 (discussed above and in the description of FIG. 7). The method then proceeds to step 660 which continues the reconfigured operation of the system 100. If the answer to step 610 is yes, then the method proceeds directly to step 640, which was discussed above.

FIG. 7 illustrates a block diagram of an integrated wind and solar power system 700, according to an aspect of the disclosure. This configuration allows for the line side converter 140 to be prioritized for solar power production. If additional reactive power is demanded then the rotor side converter 130 can be reconfigured to supply reactive power to the grid 102 by closing switch 762. When switch 762 is closed and switch 764 open (e.g., during periods when wind speed is below cut-in speed) reactive power is supplied by rotor side converter 130 and directed through inductor 170, closed switch 762, inductor 770 and fuse 790. The reconfiguration also allows for use of both converters 130, 140 together to provide reactive power in addition to solar power evacuation. The system 700 also includes a secondary power source 795 (e.g., a battery power source, power reservoir, or fuel cell power source) that is also connected to converter 150. Power sources 120 and 795 may be used simultaneously or alternately, as desired for specific grid demands.

An alternative configuration would be to eliminate the circuit path containing switch 762, inductor 770 and fuse 790, and keeping switch 764 and inductor 170 connected between rotor side converter 130 and generator 110. With this configuration, the line side converter 140 is prioritized for solar power production, and additional reactive power can be supplied by the rotor side converter 130 through generator 110 as a transformer. The generator should be kept stationary, so the rotor brake would have to be applied during this mode, or any other means that keeps the generator stationary.

The present invention has been described in terms of some specific embodiments. They are intended for illustration only, and should not be construed as being limiting in any way. Thus, it should be understood that modifications can be made thereto, which are within the scope of the invention and the appended claims. It will be appreciated that variants of the above disclosed and other features and functions, or alternatives thereof, may be combined to create many other different systems or applications. Various unanticipated alternatives, modifications, variations, or improvements therein may be subsequently made by those skilled in the art and are also intended to be encompassed by the following claims.

1. A method of operating a power generation system (100) employing a generator (110) and a solar power source (120), wherein the generator is electrically coupled to a rotor side converter (130) and a point of common coupling (PCC) (103), the PCC being electrically coupled to a line side converter (140), a DC-DC converter (150) is electrically coupled to an output of the rotor side converter and an input of the line side converter, the DC-DC converter electrically coupled to the solar power source, the method comprising:
(a) determining (310) if a wind speed is less than a cut-in speed;
(b) calculating (315) a reactive power demand for an electrical grid (102);
(c) calculating(320) a reactive power capability of the line side converter;
(d) determining (325) if the reactive power demand is greater than the reactive power capability;
(e) calculating (330) a reactive power capability of the line side converter and the rotor side converter;
(f) determining (335) if the reactive power demand is greater than the reactive power capability of the line side converter and the rotor side converter;
(g) reducing (340) solar power generation if the reactive power demand is greater than the reactive power capability of the line side converter and the rotor side converter and repeating the determining if the reactive power demand is greater than the reactive power capability of the line side converter and the rotor side converter step, or reconfiguring at least one of the line side converter and the rotor side converter to meet reactive power demand.

2-14. (canceled)

15. The method of claim 1, step (a) (310) further comprising:
determining if a wind speed is equal to or greater than the cut-in speed, and if so;
operating the generator in a default mode.

16. The method of claim 1, wherein step (c) (320) further comprises:
calculating a reactive power capability for a plurality of wind turbines, each of the wind turbines having one line side converter.

17. The method of claim 1, wherein step (d) (325) further comprises:
determining if the reactive power demand is less than or equal to the reactive power capability, and if so operating the generator in a default mode.

18. The method of claim 1, wherein step (e) (330) further comprises:
calculating a reactive power capability for a first wind turbine, and determining if the calculated reactive power capability is equal to or greater than the reactive power demand, and if not then repeating the calculating and determining steps for a second wind turbine and repeating these steps until the reactive power capability for all wind turbines in a wind farm has been calculated or the reactive power demand is equal to or less than the calculated reactive power capability.

19. The method of claim 1, wherein step (f) (335) further comprises:
determining if the reactive power demand is less than or equal to the reactive power capability of the line side converter and the rotor side converter, and if so operating the generator in a default mode.

20. The method of claim 19, wherein the default mode comprises:
a first default mode where reactive power capability is driven primarily by the generator, and wind speed is equal to or above the cut-in speed; or
a second default mode where reactive power capability is driven primarily by at least one of the line side converter and the rotor side converter, and wind speed is below the cut-in speed and the solar power source is not generating power.

21. A method of operating a power generation system (100) employing a generator (1 10) and a secondary power source (120, 795), wherein the generator is electrically coupled to a rotor side converter (130) and a point of common coupling (PCC) (103), the PCC being electrically coupled to a line side converter (140), a DC-DC converter (150) is electrically coupled to an output of the rotor side converter and an input of the line side converter, the DC-DC converter electrically coupled to the secondary power source, the method comprising:
(a) determining (310) if a wind speed is less than a cut-in speed;
(b) calculating (315) a reactive power demand for an electrical grid;
(c) calculating (320) a reactive power capability of the line side converter;
(d) determining (325) if the reactive power demand is greater than the reactive power capability;
(e) calculating (330) a reactive power capability of the line side converter and the rotor side converter;
(f) determining (335) if the reactive power demand is greater than the reactive power capability of the line side converter and the rotor side converter;
(g) reducing (340) secondary power source generation if the reactive power demand is greater than the reactive power capability of the line side converter and the rotor side converter and repeating the determining if the reactive power demand is greater than the reactive power capability of the line side converter and the rotor side converter step, or reconfiguring at least one of the line side converter and the rotor side converter to meet reactive power demand.

22. The method of claim 21, wherein step (a) further comprises:
determining if a wind speed is equal to or greater than the cut-in speed, and if so;
operating the generator in a default mode.

23. The method of claim 21, wherein step (c) further comprises:
calculating a reactive power capability for a plurality of wind turbines, each of the wind turbines having one line side converter.

24. The method of claim 21, wherein step (d) further comprises:
determining if the reactive power demand is less than or equal to the reactive power capability, and if so operating the generator in a default mode.

25. The method of claim 21, wherein step (e) further comprises:
calculating a reactive power capability for a first wind turbine, and determining if the calculated reactive power capability is equal to or greater than the reactive power demand, and if not then repeating the calculating and determining steps for a second wind turbine and repeating these steps until the reactive power capability for all wind turbines in a wind farm has been calculated or the reactive power demand is equal to or less than the calculated reactive power capability.

26. The method of claim 21, wherein step (f) further comprises:
determining if the reactive power demand is less than or equal to the reactive power capability of the line side converter and the rotor side converter, and if so operating the generator in a default mode.

27. The method of claim 26, wherein the default mode comprises:
a first default mode where reactive power capability is driven primarily by the generator, and wind speed is equal to or above the cut-in speed; or
a second default mode where reactive power capability is driven primarily by the at least one of the line side converter and the rotor side converter, and wind speed is below the cut-in speed and the secondary power source is not generating power.
